(19) United States
(12) Patent Application Publication
(10) Pub. No.: US 2005/0151968 A1
(43) Pub. Date: Jul. 14, 2005

(54) Systems and methods for continuous, on-line, real-time surveillance of particles in a fluid

(75) Inventors: David A. Drake, Escondido, CA (US); Gregory M. Quist, Escondico, CA (US)

Correspondence Address: BAKER & MCKENZIE;PATENT DEPARTMENT, 2001 ROSS AVENUE, SUITE 2300, DALLAS, TX, 75201, US

(73) Assignee: The LXT Group

(21) Appl. No.: 11/032,473

(22) Filed: Jan. 10, 2005

Related U.S. Application Data
(60) Provisional application No. 60/534,793, filed on Jan. 8, 2004.

(51) Int. Cl. G01N 21/00

(52) U.S. Cl. 356/338

(57) ABSTRACT

Disclosed herein are systems and methods for the continuous, on-line, real-time surveillance (CORTS) of microorganisms/particles. In one embodiment, a system comprises an optical illuminator for directing a light along a beam axis and onto a particle. In addition, the system comprises an angular amplifier configured to receive light scattered in a plurality of directions by the particle, and to minimize the angular dispersion of the scattered light with respect to the beam axis. The system also comprises an optical detector configured to receive at least a portion of the scattered light from the angular amplifier. A method of identifying particles comprises directing a light along a beam axis and onto a particle, and receiving light scattered in a plurality of directions by the particle. The method further comprises minimizing the angular dispersion of the scattered light with respect to the beam axis, and detecting at least a portion of the scattered light after minimizing the angular dispersion of the beam.

### CROSS REFERENCE TO RELATED APPLICATION

This Application claims the benefit of U.S. Provisional Application Ser. No. 60/534,793, filed on Jan. 8, 2004, and entitled “A Provisional Patent for a Continuous On-Line Real-Time Surveillance System,” which is incorporated herein by reference for all purposes.

### TECHNICAL FIELD

Disclosed embodiments herein relate generally to surveying particles, and more particularly to systems and methods for the continuous, on-line, real-time surveillance of microorganisms/particles by scattering light, detecting the scattered light, recognizing the source of the scattered light, tabulating the results, and communicating the results to a responsible party.

### BACKGROUND

In today's turbulent society, there is a critical need for a system that will provide continuous, on-line, real time surveillance for the presence of microorganisms in water, air and food. This need became even more acute since the terrorist attack on U.S soil on Sep. 11, 2001. The historical record of microbiological contamination includes many events that are transient in nature, have high microorganism concentrations for brief times, and would be missed by sporadic, manual testing. Common practice for protection from microorganisms uses manual sampling with swabs, water bottles or other physical means, transport to a laboratory, culturing on plates and inspection of the cultured samples. However, there are many problems with this process, including (1) the time delay in sampling and culturing, (2) the failure to detect microorganisms that do not respond to culturing (e.g., Cryptosporidium parvum, Giardia lamblia and many types of algae), (3) the narrow window of time under surveillance, allowing a high probability of missing a short duration microbiological event, (4) the high labor cost, which reduces sampling frequency, (5) the delay caused by dissemination of the test results manually, rather than by high speed communications directly, and (6) the inability to use the results in real time systems, such as the use of the results for automatic treatment augmentation or product disposal. For at least these reasons, the need for a continuous, on-line, real-time, surveillance system (CORTS) for microorganisms is high.

In addition, the probability of both naturally occurring and intentional contamination has grown. Risk of naturally occurring microorganisms has grown with population, stress on water supplies, demand for lower costs in food, the widespread use of heating, ventilation, and air conditioning (HVAC) systems, and the exposure of new microorganisms as we expand humanity into undeveloped areas. The risk of intentional microbiological contamination has grown from several sources as well, including the expansion of international terrorism, the growth of general knowledge about biological weapons, the potential for domestic terrorists to be in proximity to targets of opportunity, and the general ease with which low technology biological contaminants can be introduced into public water supplies. In short, the risks for potential contamination are great, while the conventional approaches to determine contamination are generally lacking.

### SUMMARY

Disclosed herein are systems and methods for the continuous, on-line, real-time surveillance (CORTS) of microorganisms/particles by scattering light, detecting the scattered light, recognizing the source of the scattered light, tabulating the results, and communicating the results to a responsible party. A CORTS system constructed as disclosed herein may be used to defend sources of water and food from acts of terrorism, to provide coverage during distribution and treatment, and to secure an end user of water around sensitive targets. As such, a CORTS system as disclosed herein may be configured to generate alarms based on at least: (a) specific identification of an organism of interest above a pre-set alarm concentration; (b) detection of anomalous changes in the concentrations of organisms or particles of interest; (c) detection of changes in the concentration of unknown particles; (d) detection of changes in overall or total particle concentrations; and (e) detection of changes in particles whose scattering intensities exceeds the dynamic range of the system.

In one embodiment, a system for identifying particles comprises an optical illuminator for directing a light along a beam axis and onto a particle. In addition, the system comprises an angular amplifier configured to receive light scattered in a plurality of directions by the particle, to reduce internal reflections, and to minimize the angular dispersion of the scattered light with respect to the beam axis. Furthermore, the system in this embodiment also comprises an optical detector configured to receive at least a portion of the scattered light from the angular amplifier. In another aspect, a method of identifying particles is disclosed. In one embodiment, such a method comprises directing a light along a beam axis and onto a particle, and receiving light scattered in a plurality of directions by the particle. In addition, in such embodiments, the method further comprises minimizing the angular dispersion of the scattered light with respect to the beam axis. Furthermore, the method includes detecting at least a portion of the scattered light after minimizing the angle of dispersion.

Improvements provided by the system and methods that follow the disclosed principles include faster time to detection of unacceptable contaminants, as well as a lower number of parts for a system, which results in simpler construction and a lower cost of manufacturing. In addition, the disclosed principles provide improved sensitivity to particles being examined through a limit of detection and signal to noise. Moreover, systems and methods following the disclosed principles also allow for higher angular sampling capability, as well as higher sampling rates, which allow for larger volumes to be measured.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 illustrates a block diagram of one embodiment of a continuous on-line real-time surveillance system (CORTS) for detecting microorganisms, which has been constructed according to the disclosed principles; and

FIG. 2 illustrates a block diagram of one embodiment of an environment 200 where a CORTS system constructed in accordance with the disclosed principles may be employed.

### DETAILED DESCRIPTION OF PREFERRED EMBODIMENTS

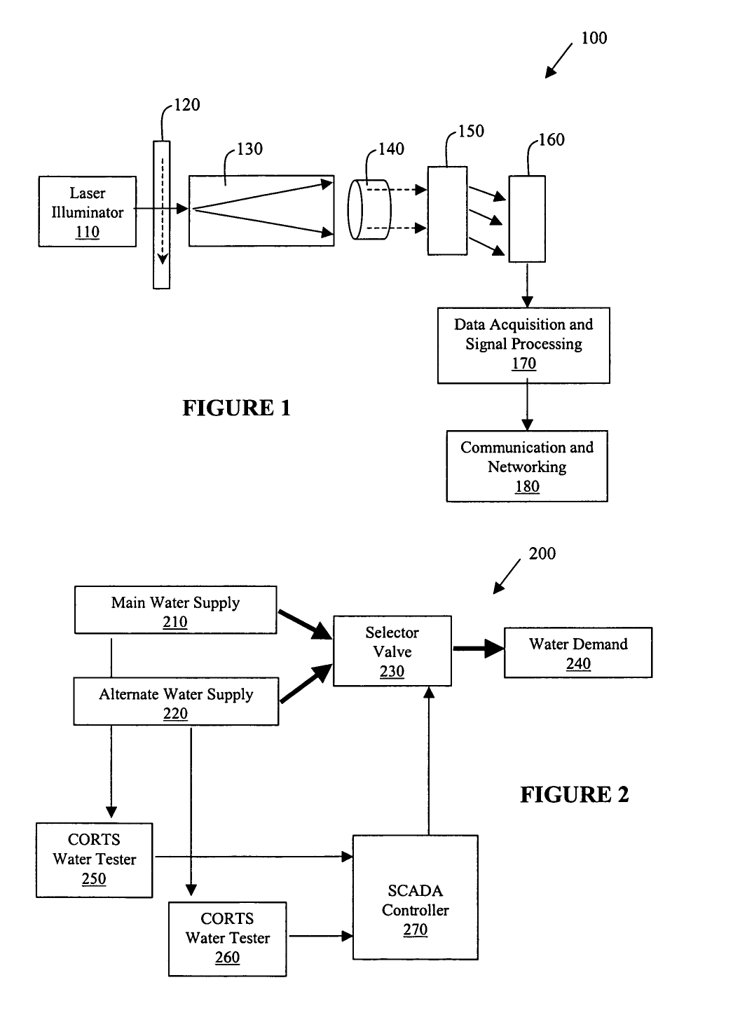

Referring initially to FIG. 1, illustrated is a block diagram of one embodiment of a continuous on-line real-time surveillance system (CORTS) 100 for detecting microorganisms, which has been constructed according to the disclosed principles. In this embodiment, the CORTS system 100 uses eight stages to detect microorganisms in real-time. These are:
1. An optical illuminator 110
2. A water flow cell 120
3. An angular amplifier 130
4. A collimator 140
5. A zone plate lens 150
6. An optical detector 160
7. A data acquisition and processing subsystem 170
8. A communications and networking subsystem 180

To begin the contamination detection of a source or supply using the disclosed approach for particle surveying, a side stream of water is directed from a main flow of water and into the water flow cell 120. Similarly, rinse water from food in a food-based system would also come through the water flow cell 120. Likewise, in an air-based system a flow of air would carry particles through the flow cell 120. The following discussion refers to water flow systems; however, it should be understood that the principles disclosed herein are equally applicable to food, air, and other types of systems. Thus, no limitation to water-based systems is intended or implied.

In such a water-based system, the side stream passes through the water flow cell 120, which has controlled dimensions for controlling water flow. The optical illuminator 110 provides a structured pattern of light that is directed to shine into a detect zone within the water flow cell 120. In the illustrated embodiment, the optical illuminator 110 generates a focused laser beam, which then illuminates a subsection of water (i.e., the detect zone) in the water flow cell 120 typically through a small aperture. In an exemplary embodiment, the beam from the optical illuminator 110 is focused along a beam axis to a size that makes it most likely that there is only one particle of water at a time in the illuminated region, based on the number of particles expected for the test environment and application.

The light is scattered by particles, such as microorganisms, that are carried in the water and through the sample flowing through the water flow cell 120. In an exemplary embodiment, the water flow cell 120 comprises a flow-through opening between about 0.1 and 10 millimeters so that a particle or microorganism can be illuminated in any portion of that aperture. For example, if there were less than 500 particles per milliliter in the water, the there would be, on average, one particle for each 2000 nanoliters. If the optical illuminator 110 illuminated only 200 nanoliters at a time then it would be very unlikely that more than a single particle would be targeted (and thus scatter the light) at any one time. Such an approach helps to minimize errors and creates a high probability of data samples that establish a clear relationship between particle type and scattered light patterns.

As the light impacts a particle, the light is scattered based on several characteristics of the illuminated particle. More specifically, the object's size, shape, index of refraction, and surface and internal details all have an effect on the angular pattern and intensity of the scattered light. As a result, the scattered light propagates from the particle or microorganism in a characteristic pattern that is unique to the particular object or particle scattering the light. The identification of the scattering object should not depend upon the orientation of the object, or its absolute position in the water flow cell 120. The geometry and design of the disclosed system is such that the orientation and the position of particles within the water flow cell 120 do not affect the detection process. Two attributes of a system constructed according to the disclosed principles provide this benefit. First, the geometry of the detection process can be circularly symmetric around the boresight (e.g., beam axis) of the system. Thus, a particle in any orientation will be detected in an equal manner. Second, the location of the scattering object should not effect the result. The optical illuminator 110 provides horizontal and vertical constraints for the illumination of the scattering object. The particle may be located along any point along the boresight, within the water flow cell 120.

To correct for this second effect, an angular amplifier 130 is placed immediately after the water flow cell 120 to collect the scattering light. The angular amplifier 130 in this embodiment is a solid transparent block with a high refractive index (e.g., 1.5-2.4) that the scattered light enters to allow a region of propagation. The angular amplifier may comprise a variety of different optically transparent substances, including optical glass, man-made sapphire (Al₂O₃), CLEARTRAN® brand optics, flint glass, polycarbonate plastic, fused quartz, and BK7 brand optics by Schott. Regardless of which substance is used, the index of refraction of the angular amplifier should be greater than the index of refraction of the flow cell. Of course, other structures capable of providing similar results may also be used for the angular amplifier 130. In an exemplary embodiment, the propagation region is several times the thickness of the water flow cell 120. For example, in a typical embodiment, the water flow cell 120 might be an opening between about 0.1 and 5 millimeters, while the angular amplifier 130 is from 5 to 100 millimeters thick. The propagation distance within the angular amplifier 130 causes the scattering launch angle from boresight to dominate the position of the light scattered and it further diminishes the importance of the location of the scattering object within the water flow cell 120.

Thus, the angular amplifier 130 assures that the position of the light further in the instrument is largely determined by the angular spectrum of light generated by the object and not by the position of the object in the water flow cell 120. The “angular spectrum” is defined as the intensity of light scattered by an object, as a function of angle from the central boresight of the optical system. The angles are measured in both azimuth and elevation, and the angular spectrum can also be a function of light polarization. Therefore, the use of an angular amplifier 130 can permit high fidelity measurements of the scattering properties of particles without regard to the position of the particle within the water flow cell 120. This is the case because the index of refraction of the angular amplifier 130 reduces or eliminates internal reflections and maintains the scattered light closer to the instrument optical axis (i.e., beam axis). As a result, the angular amplifier 130 minimizes the angular dispersion of scattered light produced by the particle passing through the flow cell 120, increasing its intensity and lowering the cost of following optics. More specifically, because the angles of the scattered light are reduced, they become easier to manage by smaller optical components (which are typically lower in cost).

Once the scattered light passes through the angular amplifier 130, as discussed above, it is then received by the collimator 140. In this embodiment, the collimator 140 is typically a short focal length lens; however, other focal lengths may also be employed. This makes the scattered light now parallel to the optical axis of the instrument. The distance from the axis to the particular light ray forms a unique mapping to the original angle at which the light ray left the original particle. Positioning the collimator 140 after the angular amplifier 130 brings the light into a path parallel with the boresight. It may also reduce the diameter of the scattered light beam to fit into a smaller zone plate lens 150 (E), which follows the collimator 140. Thus, a unique mapping exists between the original launch angle from the light scatterer in the fluid and the diameter from boresight at the output of the collimator 140.

The parallel light rays now pass to the zone plate lens 150. The zone plate lens 150 maps the distance from the central optical axis to a unique mapping that is useful for high-speed scanning. For example, the mapping can be from circular rings to a linear array of focal points, or mapping from angular segments to a linear (or other geometry) array of focal points as well. More specifically, the zone plate lens 150 pattern can be formed from rings having equal radial changes, equal angular changes, or based upon a method that normalizes scattered power to accommodate the dynamic range of the optical detector 160. It may also be formed with wedges or angular sectors as well. Of course, other types of zone plate lenses 150 may also be employed that differ in both structure and function from a circle-to-point converter, such as a rectangular pattern, a ring and wedge pattern, or a triangular pattern.

In this embodiment, the zone plate lens 150 is configured as a circle-to-point converter as described in U.S. Pat. No. 6,313,908 by Matthew J. McGill et al., assigned to the National Aeronautics and Space Administration (NASA), and entitled “Apparatus and Method using a Holographic Optical Element for Converting a Spectral Distribution to Image Points,” which is hereby incorporated by reference into this patent application. Such a circle-to-point converter maps the light rays onto a linear array of photodetectors that comprises the optical detector 160 in this embodiment. In one example, the mapping is done on an optical detector 160 that is a high-speed solid state scanner, such as a linear Charge Coupled Device (CCD) array to fully and rapidly detect the angular spectrum of scattered light. The zone plate lens 150 could also comprise other types of configurations, such as a spherical, asymmetrical, refractive element or a conical lens or mirror. One alternative embodiment would utilize a rectangular array of 64 rectangular components (preferably in an 8×8 array), wherein each component would redirect the incoming light onto a specific optical sensor. Of course, any configuration of the zone plate lens 150 may be selected such that optical patterns may be quickly scanned by solid state optical sensors, such as a linear or two-dimensional CCD, CMOS, silicon diode array, CID device or photomultiplier device, or any other optical detector 160 that converts light into an electrical signal. Moreover, the optical detector 160 may be a single point, linear, or two-dimensional array of photosensitive devices. The optical detector 160 may also include a built-in analog-to-digital converter.

The electrical signals generated by the optical detector 160 are passed to a data acquisition and data processing subsystem 170. This subsystem 170 may start with an amplifier for the analog signals, followed by an analog-to-digital converter, although this component may be omitted if the optical detector 160 contains a built-in analog-to-digital converter. The data acquisition portion of the subsystem 170 samples fast enough to capture at least several samples across each particle as it passes through the water flow cell 120. In an exemplary embodiment, the sampling rate for each frame of data is between 1,000 and 100,000 per second. Each data frame fully samples the entire angular spectrum of scattered data. For example, assume that the zone plate lens 150 forms 50 light points in a linear array. Assume further that the CCD is of length 512, putting about 5 CCD pixels on each focal point, with a dead area between each focal point of about 5 CCD pixels. If 10,000 data frames are taken each second, the CCD would be scanned at 5,120,000 pixels per second. The analog-to-digital converter would need to be sampling at about 10 MHz to capture this signal and turn it into digital data for computer processing.

Once acquired, the analog-to-digital converters communicate these signals to a computer for data analysis. Software in the computer determines in which statistical class the particle belongs. More specifically, the computer is the data processing portion of the subsystem 170, which first marshals the data into an array as a function of time. It then performs a feature extraction function to establish the existence of a scattering particle in the system 100. A particle scattering event would carry over several data frames, between two and ten, for example, depending upon water speed and particle size. The feature extraction software would determine key parameters concerning the scattered light, such as the peak values as a function of time, the relative intensities of each channel, the width of the particle event in time, or the total energy in each angular spectrum band.

A vector of features is formed by the feature extractor. Note that many data frames will contain no data. Note further that the feature vector is a significantly reduced volume of information from the original optical detector 160 data. This allows for high-speed analysis to take place after this step, with typical personal computers. The feature vector can now be assessed by a variety of statistical pattern recognition algorithms within the data processing portion. A “Principle Components Analysis” may be done to assess the angular spectrum channels that most accurately separate particles by class. “Multivariate Analysis of Variance” (MANOVA), and “Cluster Analysis” can also be applied to the feature vector for classification. The system 100 then determines the probability that the particle is a member of a given class of interest to the observer based on all this information.

Next, the particle types are tabulated and, based on a predetermined user-defined level, the software in the computer determines if an alarm is needed. For example, if the particle comes from a class of microorganisms that are considered threats, and if the tabulated probabilities for such particles exceed a threshold, then an alarm state may be determined. If an alarm state is determined, the communication and networking subsystem 180 may be configured to send the alarm by a communication means, such as wireless communications, a phone line, the Internet, or by direct local action, such as a local enunciator, computer display, or flashing light. Moreover, the subsystem 180 may also be used to update a web page, send e-mail, send a text message, or provide other means to notify an observer that a risk has been determined and needs to be assessed for action. In addition, the subsystem 180 might be used to establish an alarm in a Supervisory Control and Data Acquisition System (SCADA) for operator notification (see FIG. 2). The subsystem 180 might also be used to stop a flow of water for drinking purposes, trigger a sample gathering device, or switch to an alternate water supply.

Turning now to FIG. 2, illustrated is a block diagram of one embodiment of an environment 200 where a CORTS system constructed in accordance with the disclosed principles may be employed. The environment 200 includes a main water supply 210 and an alternative water 220, where the alternative supply 220 may be employed when the main supply 210 has been contaminated. A selector valve 230 is in place to determine which of the water supplies 210, 220 is used to fill the local water demand 240 (e.g., for a town of residents).

Also shown in FIG. 2 are two separate CORTS testers 250, 260 constructed according to the principles disclosed above. The first CORTS tester 250 is coupled to and configured to detect contamination of the main water supply 210, while the second CORTS tester 260 is coupled to and configured to detect contamination of the alternative water supply 220. The communication/networking outputs of both of the CORTS testers 250, 260 are also coupled to a SCADA, as discussed above. As a result, if the first CORTS tester 250 determines that the main water supply 210 has an unacceptable level of contamination, the first tester 250 communicates that finding to the SCADA 270, and the SCADA 270 can control the selector valve 230 to close off the main water supply 210 from the water demand 240, and fulfill the demand 240 with the alternative water supply 220. Similarly, if the second CORTS tester 260 determines that the alternative water supply 220 has an unacceptable level of contamination, the second tester 260 communicates that finding to the SCADA 270, and the SCADA 270 can control the selector valve 230 to close off the alternative water supply 210 from the water demand 240. In this situation, the water demand may be fulfilled with the main water supply 210 again, if it is determined to be substantially contamination-free, or with a third water supply (not illustrated) selectable with the valve 230.

In some embodiments, the CORTS water testers 250, 260 would be packaged in a self-contained enclosure for placement in a water supply or water use area., and could be wall or table mounted. A flow of water passes through the CORTS system and may then be returned to the water supply or discarded. In most embodiments, no chemicals are added to the water. Furthermore, a sampling device can be attached to the CORTS system. Thus, if an alarm occurs, the sampling device could capture water for later laboratory analysis and verification, if needed or desired by the user.

Still further, a CORTS system according to the disclosed principles may be trained by observing the state of a normal water supply. Furthermore, it could be trained by analyzing microorganisms or other particles of interest. The feature extraction and statistical pattern recognition software would then be used to form classes of detection. For example, a set of classes could include: normal water particles, harmless pollen, vegetative pathogenic bacteria, parasitic oocysts, harmless algae and toxic algae. Also, the system could be configured to detect and enumerate particles that fall into no known class. These could represent an outbreak or an attack by a novel microorganism and could further generate an alarm or other means of communication, as described above. Moreover, multiple CORTS systems can be used together to increase the amount of water tested, which may create a more accurate statistical sample and establish a faster time to detection.

While various embodiments of systems and methods for detecting contamination in accordance with the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A system for identifying particles, the system comprising:
an optical illuminator for directing a light along a beam axis and onto a particle;
an angular amplifier configured to receive light scattered in a plurality of directions by the particle, and to minimize the angular dispersion of the scattered light with respect to the beam axis;
an optical detector configured to receive at least a portion of the scattered light from the angular amplifier.

2. A system according to claim 1, further comprising a collimator positioned between the angular amplifier and the optical detector, and configured to collimate the portion of the scattered light before reaching the optical detector.

3. A system according to claim 1, further comprising a zone plate lens configured to direct a portion of the scattered light from the angular amplifier to the optical detector.

4. A system according to claim 1, wherein the zone plate lens comprises a holographic optical element.

5. A system according to claim 4, wherein the holographic optical element comprises at least one active holographic component configured to direct a portion of the scattered light toward the optical detector.

6. A system according to claim 3, wherein the zone plate lens is a diffractive optical element.

7. A system according to claim 3, wherein the zone plate lens is a refractive optical element.

8. A system according to claim 1, wherein the optical detector comprises a plurality of photodetectors.

9. A system according to claim 8, wherein the plurality of photodetectors comprises a linear array of photodiodes.

10. A system according to claim 9, wherein the array of photodiodes is a charge coupled device.

11. A system according to claim 1, further comprising a data acquisition and signal processing subsystem coupled to the optical detector and configured to identify the particle using the scattered light received by the optical detector.

12. A system according to claim 11, further comprising a communication subsystem coupled to the data acquisition and signal processing system and configured to communicate the identification of the particle outside the system.

13. A system according the claim 12, wherein the communication subsystem provides a warning to an interested party.

14. A system according to claim 1, further comprising a water flow cell having a detect zone within which the particle receives the light directed from the optical illuminator.

15. A system according to claim 1, wherein the angular amplifier comprises a solid transparent block.

16. A system according to claim 15, wherein the transparent block comprises a refractive index between about 1.5 and about 2.4.

17. A system according to claim 1, wherein the optical illuminator is a laser, and the directed light is a laser beam.

18. A system according to claim 17, wherein the laser is polarized.

19. A system according to claim 17, wherein the laser is unpolarized.

20. A method of identifying particles, the method comprising:
directing a light along a beam axis and onto a particle;
receiving light scattered in a plurality of directions by the particle;
minimizing the angular dispersion of the scattered light with respect to the beam axis;
detecting at least a portion of the scattered light.

21. A method according to claim 20, further comprising collimating the detected scattered light.

22. A method according to claim 20, further comprising directing the scattered light after the minimization of the angular dispersion to facilitate the detecting.

23. A method according to claim 20, further comprising directing the scattered light with a holographic optical element.

24. A method according to claim 23, wherein the holographic optical element comprises at least one active holographic component configured to direct a portion of the scattered light toward the optical detector.

25. A method according to claim 22, further comprising directing the scattered light using a diffractive optical element.

26. A method according to claim 22, further comprising directing the scattered light using a refractive optical element.

27. A method according to claim 20, further comprising detecting the at least a portion of the scattered light with a plurality of photodetectors.

28. A method according to claim 27, wherein the plurality of photodetectors comprises a linear array of photodiodes.

29. A method according to claim 28, wherein the array of photodiodes is a charge coupled device.

30. A method according to claim 20, further comprising identifying the particle using the detected scattered light.

31. A method according to claim 30, further comprising communicating the identification of the particle.

32. A method according to claim 20, further comprising minimizing the angular dispersion of the scattered light with respect to the beam axis by passing light scattered by the particle through a solid transparent block.

33. A method according to claim 32, wherein the transparent block comprises a refractive index between about 1.5 and about 2.4.
